(19) United States
(12) Patent Application Publication
(10) Pub. No.: US 2026/0313150 A1
(43) Pub. Date: Oct. 8, 2026

(54) AFFINE MOTION COMPENSATED TEMPORAL FILTER

(71) Applicant: InterDigital VC Holdings, Inc., Wilmington, DE (US)

(72) Inventors: Saurabh Puri, Montreal (CA); Charles Bonnineau, Montreal (CA); Ismail Marzuki, Montreal (CA); Renan Utida Barbosa Ferreira, Montreal (CA); Stephane Coulombe, Brossard (CA)

(73) Assignee: InterDigital VC Holdings, Inc., Wilmington, DE (US)

(21) Appl. No.: 19/169,778

(22) Filed: Apr. 3, 2025

(51) Int. Cl. H04N 19/51; H04N 19/117; H04N 19/80

(52) U.S. Cl. CPC H04N 19/51; H04N 19/117; H04N 19/80

(57) ABSTRACT

Systems, methods, and devices described herein are related to an affine motion compensated temporal filter. A device may include a processor. The device may be configured to obtain at least one temporal filter reference picture associated with a picture. The device may perform, for a block in the picture, a motion estimation associated with an advanced motion model type based on the at least one temporal filter reference picture to obtain a motion compensated block. The device may derive a motion compensated temporal filter (MCTF) at least based on the motion estimation. The device may obtain a filtered picture based at least on applying the derived MCTF on the block in the picture.

### BACKGROUND

The present application is related to video coding systems that may be used to compress digital video signals, e.g., to reduce the storage and/or transmission bandwidth needed for such signals. Video coding systems may include, for example, block-based, wavelet-based, and/or object-based systems.

### BRIEF SUMMARY

Systems, methods, and devices described herein are related to an affine motion compensated temporal filter. An encoding device may include a processor. The device may be configured to obtain at least one temporal filter reference picture associated with a picture. The device may perform (e.g., for a block in the picture) a motion estimation associated with an advanced motion model type based on the at least one temporal filter reference picture to obtain a motion compensated block. The device may derive a motion compensated temporal filter (MCTF) at least based on the motion estimation. The device may obtain a filtered picture based at least on applying the derived MCTF on the block in the picture.

The device may include one or more features. For example, the device may determine a first prediction error associated with the motion compensated block. The device may perform (e.g., for the block in the picture) a second motion estimation associated with a second motion model type based on the at least one temporal filter reference picture to obtain a second motion compensated block. The device may determine a second prediction error associated with the second motion compensated block. The device may derive the MCTF based on a comparison of the first prediction error and the second prediction error. The MCTF may be derived based on the advanced motion model type if the first prediction error is less than the second prediction error. The MCTF may be derived based on the second motion model type if the second prediction error is less than the first prediction error.

The device may store a motion model type, a motion vector, a motion model parameter, or a prediction error value associated with the MCTF. The motion estimation may be based on a temporally neighboring reference picture. The second motion estimation may be performed based on a hierarchical motion estimation. The advanced motion model type may include at least three motion model parameters. The advanced motion model type may be at least one of an affine motion model, a perspective motion model, a homographic motion model, a piecewise motion model, or an artificial intelligence (AI)-based motion model. The device may encode a second picture by using the filtered picture as a reference picture. The second picture may be encoded after encoding the filtered picture. The at least one temporal filter reference picture may include at least one of a preceding neighboring picture in a display order of a group of pictures, or a succeeding neighboring picture in the display order of the group of pictures. The derived MCTF may be applied on the block in the picture during pre-processing.

Systems, methods, and devices described herein are related to an affine motion compensated temporal filter. An encoding device may include a processor. The device may be configured to obtain at least one temporal filter reference picture associated with a first picture. The device may perform, for a block in the first picture, a first motion estimation associated with a first motion model type based on the at least one temporal filter reference picture to obtain a first motion compensated block. The device may determine a first prediction error associated with the first motion compensated block. The device may perform, for the block in the first picture, a second motion estimation associated with a second motion model type based on the at least one temporal filter reference picture to obtain a second motion compensated block. The device may determine a second prediction error associated with the second motion compensated block. The device may derive a MCTF based on a comparison of the first prediction error and/or the second prediction error. The device may obtain a filtered first picture based at least on applying the derived MCTF on the block in the first picture. The device may encode a second picture by using the filtered first picture as a reference picture.

The device may include one or more features. For example, the filtered first picture may be encoded first. The second picture may be encoded after the encoding of the first picture. The at least one temporal filter reference picture may include at least one of a preceding neighboring picture in a display order of a group of pictures, or a succeeding neighboring picture in the display order of the group of pictures. Applying the derived MCTF on the block in the first picture may be performed during pre-processing. The processor may be further configured to store a motion model type, motion model parameters, a motion vector, or a prediction error value associated with the MCTF. The MCTF may be derived based on the first motion model type if the first prediction error is less than the second prediction error. The MCTF may be derived based on the second motion model type if the second prediction error is less than the first prediction error. The MCTF may be derived based on a (e.g., advanced) motion model (e.g., without comparing a first motion model to a second motion model type).

The second motion model type may be at least one of an affine motion model, a perspective motion model, a homographic motion model, a piecewise motion model, or an AI-based motion model (e.g., a neural network, a deep neural network and/or the like). The first motion estimation may be based on a temporally neighboring reference picture and/or the first motion estimation may be performed based on a hierarchical motion estimation. The first prediction error may include a first translational error value from a first sub-block and/or a second translational prediction error value from a second sub-block.

A device for video encoding may be configured to obtain at least one pre-processing temporal filter reference picture associated with a first picture. The device may perform, for a block in the first picture, pre-processing motion estimation using an affine motion model based on the at least one pre-processing temporal filter reference picture. The device may obtain at least one motion compensated block based on the affine motion model. The device may derive a MCTF based on the at least one motion compensated block. The device may obtain a filtered first picture based on at least on applying the derived MCTF on the block. The device may encode a second picture by using the filtered first picture as a reference picture.

In examples, the first picture may include a first block. The device may perform, for a second block in the first picture, a first pre-processing motion estimation using the affine motion model based on the at least one pre-processing temporal filter reference picture. The device may obtain a second affine motion compensated block based on the affine motion model. The device may perform, for the second block in the first picture, a second pre-processing motion estimation using a translational motion model based on the at least one pre-processing temporal filter reference picture. The device may obtain a second translational motion compensated block based on the translational motion model. The device may select, between the second affine motion compensated block and/or the second translational motion compensated block, a motion compensated block having a lower prediction error. The device may derive a second MCTF based on the selected motion compensated block. The filtered first picture may be obtained further based on applying the second MCTF on the second block in the first picture.

A device for video encoding may be configured to, prior to encoding a group of pictures, obtain at least one temporal filter reference picture associated with a first picture of the group of pictures. The device may perform, for a block in the first picture, a first motion estimation associated with a first motion model type based on the at least one temporal filter reference picture to obtain a first motion compensated block. The device may perform, for the block in the current picture, a second motion estimation associated with a second motion model type based on the at least one temporal filter reference picture to obtain a second motion compensated block. The device may select, between the first and/or second motion model, a motion model associated with a lower prediction error for the block. The device may derive a MCTF based on the selected motion model. The device may obtain a filtered first picture based at least on applying the derived MCTF on the block in the first picture. The device may encode a second picture by using the filtered first picture as a reference picture.

A method may be performed based on one or more features as described herein.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings.

FIG. 1 shows an example system according to one or more embodiments of the present disclosure.

FIG. 2 shows an example video encoder according to one or more embodiments of the present disclosure.

FIG. 3 shows an example video decoder according to one or more embodiments of the present disclosure.

FIG. 4A illustrates an example of a two control point (e.g., four-parameter) affine model.

FIG. 4B illustrates an example of a three control point (e.g., six-parameter) affine model.

FIG. 5 illustrates an example of an affine motion vector field (MVF) per subblock.

FIG. 6 illustrates an example VTM random access (RA) picture referencing structure.

FIG. 7 Illustrates an example of hierarchical motion estimation layers.

FIG. 8 illustrates an example of an affine structure to store control points.

FIG. 9 Illustrates an example of an affine structure to store a sub-block motion vector and/or a prediction error.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

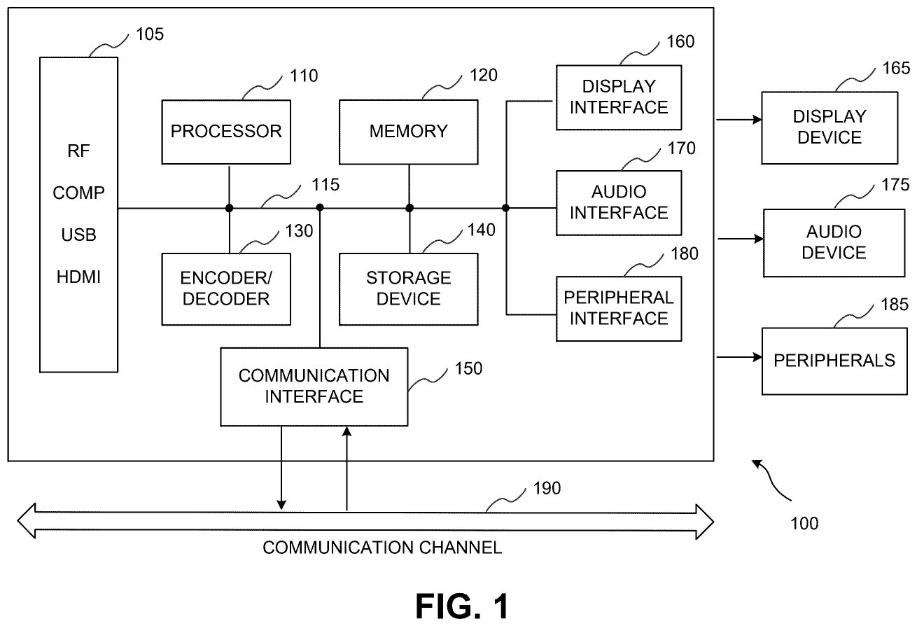

Referring to the drawings, there is shown in FIG. 1 a block diagram illustrating an example system 100 in which embodiments of the present disclosure can be implemented. The system 100 may be an electronic device including, for example, a personal computer, laptop computer, mobile phone, tablet computer, multimedia set-top box, digital television receiver, personal video recording system, connected home appliance, vehicle control and/or entertainment system, and server. One or more elements of the system 100, singly or in combination, may be implemented as an integrated circuit (IC), multiple ICs, and/or discrete components. For example, in one embodiment, the processing, encoding and/or decoding elements of system 100 are distributed across multiple ICs and/or discrete components. In some embodiments, the system 100 is communicatively coupled to and/or in communication with other systems or devices, via, for example, a communications bus or dedicated input/output ports.

One or more of the elements of system 100 may be provided within an integrated housing, with such elements being interconnected and able to transmit data therebetween using any suitable connection arrangement 115 generally known in the art, including, for example, an internal bus (e.g., I2C bus), wiring, and printed circuit boards.

The system 100 may include at least one processor 110 configured to execute instructions for implementing the embodiments described herein, including signal/data coding and processing. The processor 110 may be a general-purpose processor or microprocessor, digital signal processor (DSP), one or more microprocessors in association with a DSP core, a controller, a microcontroller, application specific integrated circuits (ASICs), field programmable gate arrays (FPGAs), a state machine, and the like. The processor 110 may include at least one central processing unit (CPU), embedded memory, input and output interfaces, and other circuitries.

The system 100 may include at least one memory 120, for example, a volatile memory device and/or a non-volatile memory device. The system 100 may include a storage device 140, that may be or include non-volatile memory and/or dynamic volatile memory, including EEPROM, ROM, PROM, RAM, DRAM, SRAM, DDR, flash, magnetic disk drives, solid state drives (SSD) and/or optical disk drives. The storage device 140 may be or include, for example, an internal storage device, an attached storage device, and/or a network accessible storage device. Although shown separately, the memory 120 and the storage device 140 may be collocated, integrated together, or otherwise combined.

The system 100 may include an encoder/decoder module 130 configured to process video data and to provide encoded video data or decoded video data. The encoder/decoder module 130 may include one or more processors and/or memory (not shown). Although FIG. 1 depicts the encoder/decoder module 130 as a separate element of system 100, it will be understood that the processor 110 and the encoder/decoder module 130 may be collocated and/or integrated together as a combination of hardware and/or software, e.g., in an electronic package or chip. The encoder/decoder module 130 may be or include one or more modules that may be included in one or more separate devices that perform encoding and/or decoding functions.

Instructions for execution by the processor 110 and/or the encoder/decoder module 130 may be stored in the storage device 140 and subsequently loaded into memory 120 for execution by the processor 110. In some embodiments, one or more of processor 110, memory 120, storage device 140, and encoder/decoder module 130 may store one or more items when performing the processes disclosed herein. Such items may include input video, decoded video or portions thereof, bitstreams, matrices, variables, operational logic, and intermediate and/or final results from processing of equations, formulas, or operations.

In some embodiments, the memory of the processor 110 and/or the encoder/decoder module 130 may be used to store instructions and/or provide working memory for video encoding and decoding functions. In some embodiments, memory external to the processor 110 and/or the encoder/decoder module 130 (e.g., the memory 120 and/or the storage device 140) may be used for one or more of these functions and/or, for example, to store the operating system of a television.

The system 100 may obtain or receive information via one or more input devices, interfaces, and/or ports as indicated in input block 105. Examples of the input devices include a radio frequency (RF) device for transmitting and/or receiving RF signals over various media, for example, RF signals received over the air from a broadcaster; component video (COMP) inputs; a Universal Serial Bus (USB) input; and/or a High-Definition Multimedia Interface (HDMI) input. Other examples include composite video input (not shown). In some embodiments, the input devices are associated with respective input processing elements, e.g., those generally known in the art. For example, the RF device may be associated with elements suitable for selecting a desired frequency (e.g., selecting or band-limiting a signal) or performing error correction on the signal. The USB and/or HDMI inputs may include respective interface processors and transceivers (or transmitters and receivers) for coupling the system 100 to other devices via USB and/or HDMI ports or connections. Various forms of input processing may be implemented, for example, by and/or within a separate input processing device or the processor 110.

The system 100 may include a communication interface 150 that enables wired and/or wireless communication with other devices, e.g., via a communication channel 190. The communication interface 150 may include one or more transceivers, modems, network cards and the like. The communication channel 190 may be or include wired and/or wireless mediums.

In some embodiments, data may be streamed to the system 100 via wired and/or wireless networks. Examples of such wireless networks include cellular, Bluetooth or Wi-Fi (e.g., IEEE 802.11) networks. The wired and/or wireless networks may include one or more base stations (e.g., cellular base stations, access points, etc.), and/or user equipment (e.g. cellular user equipment, stations, etc.), and/or other network elements that communicate with the system 100 via the communication interface 150 and communication channel 190, whereby the system 100 may obtain data streamed from streaming applications (e.g., OTT services) via various networks, including the Internet. In some embodiments, data is streamed to the system 100 via the input block 105 (e.g., using a set-top box that delivers data via the HDMI connection or the RF connection). In some embodiments, data is received by the system 100 in a non-streaming manner.

The system 100 may provide one or more output signals to one or more output devices. The output devices may include a display device 165 (e.g., touchscreen display, monitor, etc.), an audio device 175 (e.g., speakers), and other peripheral devices 185, including, for example, a stand-alone DVR, a disk player, a stereo system, a lighting system, and other devices that provide a function based on the output of the system 100. The display device 165 can be for a television, tablet, laptop, mobile phone, head-mounted display, or other device. In some embodiments, control signals are communicated between the system 100 and the display device 165, the audio device 175, and/or the peripheral devices 185, enabling device-to-device control with or without user intervention. The output devices may couple to and/or communicate with the system 100 via dedicated connections via respective display, audio, and peripheral interfaces 160, 170, 180. Alternatively, the output devices may couple to and/or communicate with the system 100 via the communication channel 190 and the communication interface 150.

The display device 165 and the audio device 175 may be collocated, integrated, or otherwise combined with the other components of system 100 in a single unit (e.g., a television). Alternatively, the display device 165 and the audio device 175 may be separate from one or more of the other components of the system 100. In embodiments in which the display device 165 and the audio device 175 are external components, the output signals may be provided via dedicated outputs and/or connections, including, for example, HDMI ports, USB ports, or COMP outputs.

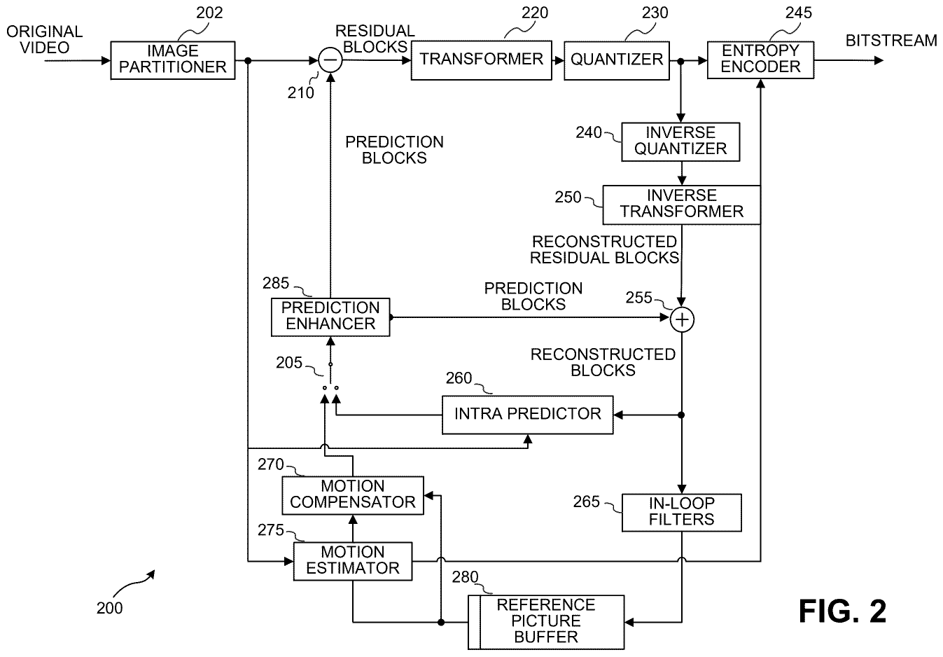

FIG. 2 is a block diagram illustrating an example video encoder 200 that may be employed by the system 100 (e.g., via the encoder/decoder module 130) described with respect to FIG. 1. The video encoder 200 may be an encoder that employs video compression technologies, standards, specification, or protocols, including Advanced Video Coding (AVC, H.264/MPEG-4), High Efficiency Video Coding (HEVC, H.265), Versatile Video Coding (VVC, H.266), Essential Video Coding (EVC, MPEG-5), AOMedia Video 1 (AV1), VP9, or the Enhanced Compression Model (ECM), and variations or improvements thereof. Those skilled in the art will understand that the various embodiments described herein are not limited to a specific standard and can be applied to other standards and recommendations, as well as extensions thereof.

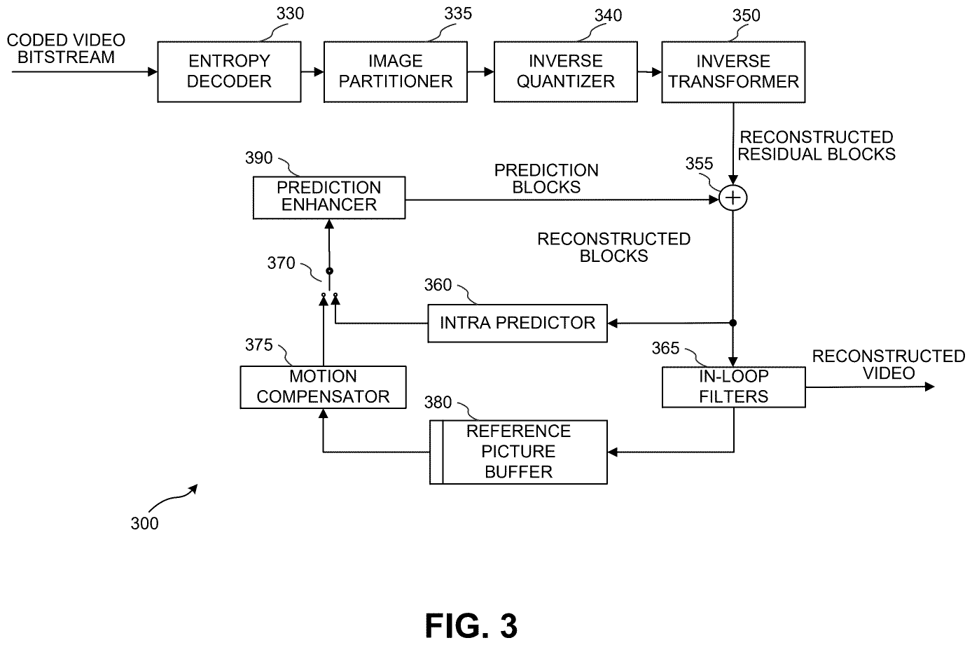

Some embodiments disclosed herein are described with reference to a coding unit (CU) or block of a video frame (or a video image or picture) to which coding tools may be applied by the video encoder 200 and/or by the video decoder 300 (described below with reference to FIG. 3). Generally, embodiments described herein may be applied to a video region formed by a video partition of any shape or size. The video region may be a video slice, a coding tree unit (CTU), or a CU (to which inter prediction or intra prediction can be applied), or a partition thereof, each of which can include samples of a luma component, Y, and chroma components, U and V (also denoted herein by C, Cb, Cr).

Referring generally to FIG. 2 and the video encoder 200, video data (e.g., one or more video frames) is encoded generally as described below. Prior to encoding, video data may be pre-processed by a precoding processor (not shown). The pre-processing may include, for example, applying a color model transform to the input color components of the input video data (e.g., conversion from RGB 4:4:4 to YUV 4:2:0) or mapping the color components of the input video data to obtain a signal distribution that is more resilient to compression (for instance, applying a histogram equalizer and/or a denoising filter to one or more of the video data's color components). The pre-processing may include associating metadata (for example, a supplemental enhancement information (SEI) message) with the video data that can be attached to a coded video bitstream. After pre-processing, if any, an image (frame) to be encoded is partitioned into CUs (blocks) by an image partitioner 202.

In general, a CU may include a luma block and associated chroma blocks. As such, functions of the video encoder 200 described herein as applied to a CU refer generally to the luma block and the respective chroma blocks. The CUs may be encoded using an intra prediction mode performed by an intra predictor 260. In intra prediction mode, the content of a CU in a frame is predicted based on content from one or more other CUs of the same frame (or region), using reconstructed blocks of other CUs output from an adder 255. The CUs may also or alternatively be encoded using an inter prediction mode, in which motion estimation and motion compensation are performed by a motion estimator 275 and a motion compensator 270, respectively. In inter prediction mode, the content of a CU in a frame is predicted based on content from one or more reconstructed areas of reference frames, available from a reference picture buffer 280.

The video encoder 200 selects or otherwise determines at 205 which prediction mode (intra prediction mode and/or inter prediction mode) to use for encoding a CU. The selected prediction mode may be enhanced (e.g., filtered) by a prediction enhancer 285. Based on the selected mode, a prediction for the CU is generated. A residual block is determined based on the prediction (e.g., prediction block, predicted CU) and the input CU. In some embodiments, such determination is made by a subtractor 210.

The residual block or a partition thereof (e.g., a transform block) is transformed into transform coefficients by a transformer 220. The transform coefficients are quantized by a quantizer 230. An entropy encoder 245 performs entropy encoding of the quantized transform coefficients and coding parameters (e.g., syntax elements including motion vectors and other control data) to form a bitstream of coded video data.

In addition to coding the original video blocks as described herein, the video encoder 200 reconstructs the coded blocks to provide references for future predictions. Thus, quantized transform coefficients (from the quantizer 230) are de-quantized by an inverse quantizer 240, and inverse transformed by an inverse transformer 250, to reconstruct (decode) the residual blocks. The reconstructed residual blocks and prediction blocks are combined (e.g., by the adder 255) to form reconstructed blocks. Thus, the video encoder 200 performs decoding operations through which the encoded images (frames) are reconstructed.

In-loop filters 265 may be applied to the reconstructed image (formed by the reconstructed blocks). The filtered reconstructed image(s) are stored in the reference picture buffer 280 and used by the motion estimator 275 and motion compensator 270, as explained above. The in-loop filters 265 can be applied to the reconstructed samples of an image to reduce distortions introduced by the encoding process. For example, a deblocking filter (DBF), bilateral filter (BIF), sample adaptive offset (SAO), and/or adaptive loop filter (ALF) can be applied to reduce encoding artifacts.

FIG. 3 is a block diagram illustrating an example of video decoder 300 that may be employed by the system 100 (e.g., via the encoder/decoder module 130) described with respect to FIG. 1. Generally, operational features of the video decoder 300 are reciprocal to operational features of the video encoder 200. In the video decoder 300, a coded video bitstream (e.g., generated by the video encoder 200 or another video encoding device or process) is entropy-decoded by an entropy decoder 330 to obtain transform coefficients, motion vectors, and other coding parameters. Based on the coding parameters, an image partitioner 335 divides the picture accordingly. The quantized transform coefficients are de-quantized by an inverse quantizer 340 and inverse transformed by an inverse transformer 350 to decode (e.g., reconstruct) respective residual blocks. Depending on the selected prediction mode, a predicted block can be obtained at 370 from an intra predictor 360 (e.g., intra prediction) or from a motion compensator 375 (e.g., inter prediction) and may be enhanced (e.g., filtered) by a prediction enhancer 390, generating a prediction block. The reconstructed residual blocks are combined with prediction blocks (e.g. by an adder 355), resulting in reconstructed blocks.

In-loop filters 365 (e.g., DBF, BIF, SAO, and/or ALF) can be applied to the reconstructed image (formed by the reconstructed blocks), to output reconstructed (decoded) video. The filtered reconstructed image is also stored in a reference picture buffer 380 for reference by the motion compensator 375.

A post-decoding processor (not shown) can process the reconstructed video data. For example, post-decoding processing can include an inverse color model transform (e.g., conversion from YUV 4:2:0 to RGB 4:4:4) or an inverse mapping to reverse the mapping process performed by the pre-encoding processor described with respect to FIG. 2. The post-decoding processor can use metadata derived by the pre-encoding processor and/or signaled in the video bitstream.

A motion compensation temporal filter (MCTF), interchangeably referred to herein as a pre-filter, may include an affine motion model (e.g., an advanced motion model) to optimize the motion prediction stage associated with the MCTF. Efficient modeling of the motion that may not be translational (e.g., the motion may include transformational motion including zooming in and out, rotation, and/or the like) may be described herein. With optimized motion prediction, the interpolation of intermediate frames that are filtered using a bi-lateral filter may be further optimized. An optimal preservation of edges and/or high frequency textures while improving the filtering of the smooth regions of the frames may be described herein. One or more examples may provide coding gains and/or reduce encoding time.

Affine motion compensated prediction may be described herein.

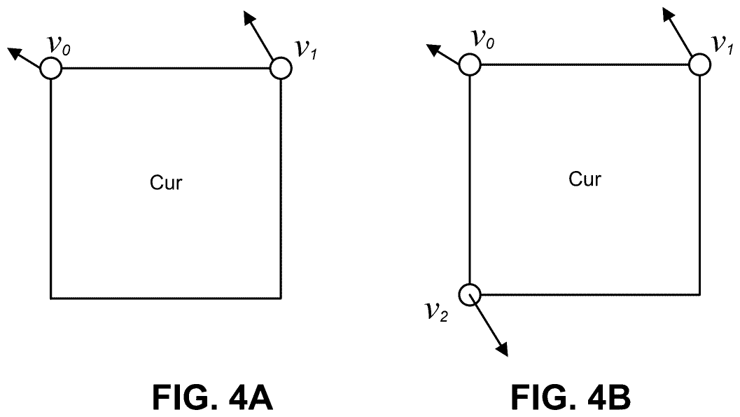

A translation motion model may be applied for motion compensation prediction (MCP). There may be one or more kinds of motion, e.g., zoom in/out, rotation, perspective motions and the other irregular motions (e.g., including transformational motion). A block-based affine transform MCP may be applied. As shown FIGS. 4A-4B, the affine motion field of the block may be described by motion information of two control point (e.g., four-parameter) motion vectors or three control point motion vectors (six-parameter).

FIGS. 4A-4B illustrate example control point-based affine motion model(s). FIG. 4A illustrates an example four-parameter affine model. FIG. 4B illustrates an example six-parameter affine model.

For a four-parameter affine motion model, a motion vector at sample location (x, y) in a block may be derived as:

$$\{ \begin{matrix}{mv}_{x} = \frac{{mv}_{1 x} - {mv}_{0 x}}{W} x + \frac{{mv}_{0 y} - {mv}_{1 y}}{W} y + {mv}_{0 x} \\ {mv}_{y} = \frac{{mv}_{1 y} - {mv}_{0 y}}{W} x + \frac{{mv}_{1 x} - {mv}_{0 x}}{W} y + {mv}_{0 y}\end{matrix} \qquad ( 1 )$$

For a six-parameter affine motion model, motion vector at sample location (x, y) in a block may be derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} \qquad ( 2 )$$

Where (mv₀ₓ, mv_{0y}) may be a motion vector of the top-left corner control point, (mv₁ₓ, mv_{1y}) may be a motion vector of the top-right corner control point, and/or (mv₂ₓ, mv_{2y}) may be a motion vector of the bottom-left corner control point.

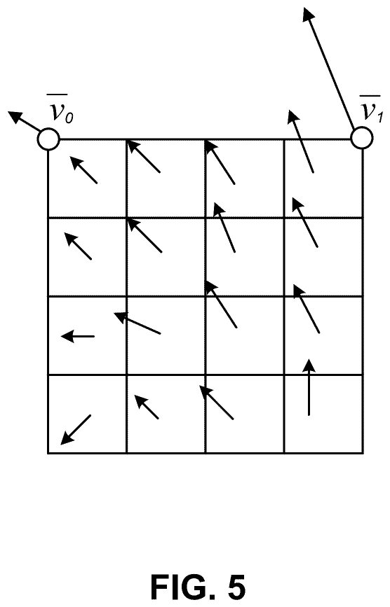

To simplify the MCP, block based affine transform prediction may be applied. To derive a motion vector of a (e.g., each) 4×4 luma subblock, the motion vector of the center sample of a (e.g., each) subblock, as shown in FIG. 5, may be calculated based on equations (1) and/or (2), and/or rounded to 1/16^{th} fraction accuracy. The motion compensation interpolation filters may be applied to generate the prediction of a (e.g., each) subblock with a derived motion vector.

FIG. 5 illustrates an example of an affine motion vector field (MVF) per subblock.

One or more examples may prefilter a video (e.g., and/or image) prior to compression. Examples may rely on translational motion models to compute the motion vectors per block. An affine or perspective motion model may provide optimized (e.g., better) predicted frame, which may improve the filtering of the video (e.g., or image). Examples described herein, may be related to an advanced motion model (e.g., an affine motion model and/or the like that may include at least three motion model parameters) in competition with the translational motion model. One or more (e.g., several) architectural changes may be proposed on top of the motion compensated temporal pre-filter.

The MCTF (e.g., and/or a motion compensated temporal bilateral denoising prefilter) may be described herein.

A temporal pre-filter for video coding based on bilateral filtering may be described herein.

A motion compensated temporal bilateral denoising pre-filter for video coding may be described herein. A pre-filter may be applied to an image (e.g., an original image), prior to the compression. The prefilter may be a bilateral filter (e.g., a non-linear example) that may blur an image while respecting strong edges. A prefilter may be a temporal filter (e.g., not a spatial or spatiotemporal filter).

The filtering may use at least two preceding pictures (e.g., the closest preceding pictures) for random access (RA) and/or low-delay (LD), and/or at least two (e.g., succeeding) pictures (e.g., the two closest succeeding pictures) for RA. The filtering may use the position of the picture in the group of pictures (GOP) hierarchy and/or the quantization parameter (QP) value.

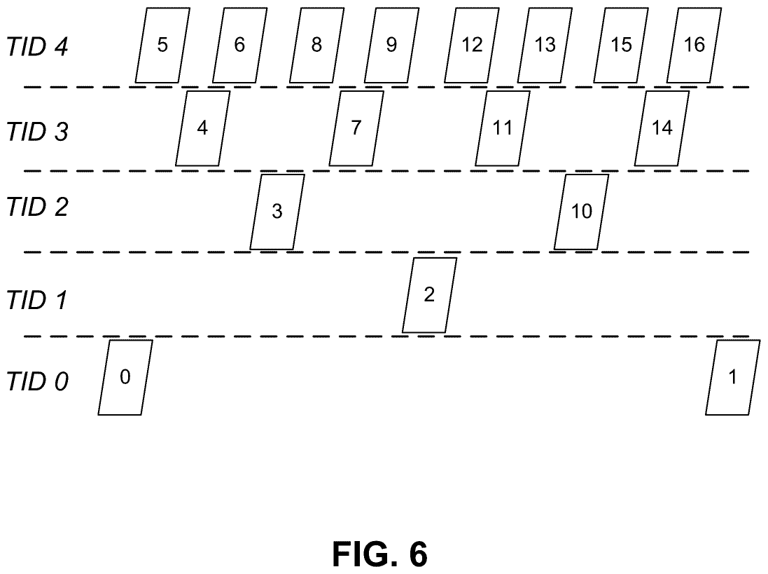

FIG. 6 illustrates an example of a VVC test model (VTM) RA picture referencing structure.

The filtering process for the RA configuration may be applied (e.g., only) to pictures with a temporal ID (TID) value equal to 0 or 1 (see FIG. 6), since these pictures may be referenced (e.g., the most) and/or encoded to a higher fidelity than other pictures. A picture may be referred to herein as the temporal filter reference picture. The (e.g., overall) filtering strength may depend on the position:

$${s}_{0} ( n ) = \{ \begin{matrix}1.5 , & n = 0 , 16 , 32 , etc \\ 0.95 , & n = 8 , 24 , 40 , etc \\ 0 , & otherwise\end{matrix} \qquad ( 3 )$$

The filtering process for the LD configuration may be applied to an eighth frame (e.g., only to every eighth frame). An eight frame may be pictures that are encoded with higher fidelity and/or available longer for direct reference (e.g., since all may have a TID equal to 0). The (e.g., overall) filtering strength may be (e.g., weaker than for RA):

$${s}_{0} ( n ) = \{ \begin{matrix}0.4 , & n = 0 , 8 , 16 , etc \\ 0 , & otherwise\end{matrix} \qquad ( 4 )$$

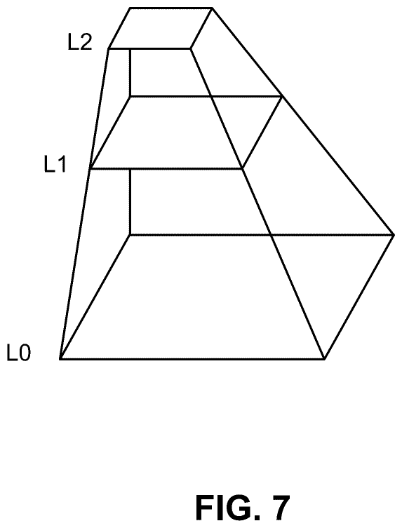

Motion compensation may use one or more (e.g., the two closest) preceding pictures (e.g., if present for RA and/or LD). Motion compensation may use one or more (e.g., the two closest succeeding) pictures (e.g., if present, for RA). Motion compensation may use 1/16^{th} sample precision motion vectors and/or interpolation filters. Motion compensation may use blocked-based hierarchical motion estimation on luma (e.g., images subsampled twice by averaging, as illustrated in FIG. 7).

FIG. 7 illustrates an example of hierarchical motion estimation layers. Hierarchical motion estimation may include one or more operations:

A +/−8 full-pel full search for a (e.g., each) 16×16 luma of L2 may be performed.

A +/−2 full-pel full search for a (e.g., each) 16×16 of L1 may be performed.

A full search for a (e.g., each) 16×16 of L0 may be performed.

A (e.g., each) 8×8 block may be refined +/−3 quarter-pel full search.

A (e.g., each) 8×8 block may be refined +/−3 1/16 full search.

The temporal bilateral filter may be applied as included in equation (5), where I₀ may be replaced by I, as follows:

$${I}_{n} = \frac{{I}_{0} + {\sum }_{i = - 2}^{2} {w}_{r} ( i , a ) * {I}_{r} ( i )}{1 + {\sum }_{i = - 2}^{2} {w}_{r} ( i , a )} \qquad ( 5 )$$

Where i may be the output distance from the current picture, a may be the number of motion-compensated pictures, wᵣ(i,a) may be the weight factor applied to Iᵣ(i) provided as:

$${w}_{r} ( i , a ) = {s}_{l} * {s}_{0} ( n ) * {s}_{r} ( i , a ) * {e}^{\frac{Δ {I ( i )}^{2}}{2 * {{σ}_{l} ( QP )}^{2}}} \qquad ( 6 )$$

$$with$$

$${s}_{l} = 0.4$$

$${s}_{r} ( i , 2 ) = \{ \begin{matrix}0. , & i = 0 \\ 1.2 , & \vert i \vert = 1 \\ 1. , & \vert i \vert = 2\end{matrix}$$

$${s}_{r} ( i , 4 ) = \{ \begin{matrix}0. , & i = 0 \\ 0.85 , & \vert i \vert = 1 \\ 0.6 , & \vert i \vert = 2\end{matrix}$$

$${σ}_{l} ( QP ) = 3 * ( QP - 10 )$$

$$Δ I ( i ) = ( {I}_{r} ( i ) - {I}_{0} ) * ( \frac{1024}{{2}^{b}} )$$

Improvements to the temporal filter may be described herein.

An optimized temporal filter may be proposed. Equation (6) may remain unchanged but wᵣ(i,a), the weight factor applied to Iᵣ(i), may be modified as follows:

$${w}_{r} ( i , a ) = bw \cdot {s}_{0} \cdot {s}_{r} ( i , a ) \cdot {e}^{\frac{- Δ {I ( i )}^{2}}{sw \cdot {{σ}_{l} ( QP )}^{2}}} \qquad ( 7 )$$

Where bw is an (e.g., new) adjustment term, and/or sw is an (e.g., new) adjustment term.

The values of bw and sw may be computed as described herein. A block error weighting may be considered. The block error weighting may calculate an error value E based on luma for a (e.g., each) 8×8 block that will be filtered:

$$E = 20 \cdot \frac{SSD + 5}{V + 5} + \frac{SSD}{{s}^{2} \cdot 50} \qquad ( 8 )$$

The sum of squared differences (SSD) may be the difference between the original luma block and the corresponding luma block in the motion-compensated neighboring picture.

V may be the variance of the current luma block.

s may be the size of the current luma block (e.g., 8×8=64).

For (e.g., low) values of E, the motion estimation may produce an accurate motion vector and/or a (e.g., higher) filtering strength may be used. For (e.g., high) values of E, the motion estimation may be determined (e.g., the motion estimation may be more uncertain, and/or the filtering may be more cautious). In examples, a high bw for low values of E may be included:

$$bw = \{ \begin{matrix}1.2 bw , & E < 50 \\ 0.6 bw , & E > 100 \\ bw , & else\end{matrix}$$

$$sw = \{ \begin{matrix}0.8 sw , & E \geq 50 \\ sw , & else\end{matrix}$$

To include a (e.g., stronger) filter weight for the blocks that are (e.g., most) similar, e.g., include the smallest error E, the base weight bw may be adjusted based on the block error E in relation to the minimal block error of (e.g., all) temporally adjacent blocks, designated min(E). E_{cur} may mark the error of the block in the (e.g., currently) processed neighboring picture. The following equation is provided:

$$bw = bw \cdot \frac{min ( E ) + 1}{{E}_{cur} + 1}$$

A block frequency dependent weighting may be described herein. bw and/or sw may be adjusted based on a frequency-dependent error value F that may be calculated for a (e.g., each) block that will be filtered. The computation operations may include: computing a difference block D, between the block in the current picture and the corresponding block in the motion compensated neighboring picture; summing the squared differences between horizontally neighboring sample values HSD in D; and/or summing the squared differences between vertically neighboring sample values VSD in D.

$$F = \frac{300 \cdot SSD + 50}{10 \cdot ( HSD + VSD ) + 50} \qquad ( 9 )$$

The computations operations may include an adjustment to bw and sw provided as:

$$bw = \{ \begin{matrix}0.6 bw , & F \geq 25 \\ bw , & else\end{matrix}$$

$$sw = \{ \begin{matrix}0.8 sw , & F \geq 25 \\ sw , & else\end{matrix}$$

There may be changes to the motion estimation operation. For example, the hierarchical motion estimation operation may be modified.

In an operation that determines the motion vector for a block (e.g., the final motion vector for each block), the full pixel grid search may be skipped. Instead, the search may continue (e.g., directly) with 1/16-sample refinement.

After retrieving the optimal (e.g., best) motion vector from the higher hierarchical layer, the zero-motion vector may be evaluated (e.g., may always be evaluated).

After the fractional motion estimation is completed, the motion vectors from the above and left blocks (e.g., in case these are available), may be evaluated and/or used (e.g., if they result in a lower SSD).

In an optimized version of an operation, the filter runtime may be reduced by a factor of about 17 compared to one or more other operations. Improvements may be obtained by improving the motion estimation process. The prefilters described herein may perform block matching on image regions prior to applying a temporal bilateral filter. If the regions are similar (e.g., if the regions match perfectly), a temporal filter may reduce noise (e.g., the temporal filter may get rid of the noise). If the regions are similar (e.g., the regions match perfectly and do not spatially change with time, or change very slowly compared to the frame rate) a temporal filter may be optimal (e.g., if/when the regions are spatially static). A temporal filter may not be optimal if the regions do not match because of one or more of the following reasons: if the motion is not translational (e.g., transformational motion including zooming in and out, 360 videos, and/or the like); if an object shape changes e.g., moving the head); and/or if there are illumination change(s).

An advanced motion model (e.g., such as an affine motion model which may include at least three motion model parameters) may provide an optimized motion prediction. The tools using advanced motion (e.g., affine) may be used in the inter coding of the frames and/or may provide (e.g., significant) coding gains. Examples described herein may use an advanced (e.g., affine, perspective) motion model in competition with a translation motion model (e.g., an existing translation motion model that includes up to two motion model parameters, e.g., a horizontal component and a vertical component) in the prefiltering stage to optimize the filtering stage.

Examples described herein may include one or more of the following: the storage of an affine motion model; an extension of the pre-filter to use an affine motion model; initializing an affine motion model from neighboring blocks; an enhanced motion model; and/or a generalized use of advanced motion model(s) in a competition (e.g., a comparison of advanced motion mode(s) including three or more motion model parameters with a second motion model).

The MCTF (e.g., pre-filter) tool may use a motion model (e.g., more advanced motion models including at least three motion model parameters as described herein), such as an affine motion in addition to and/or in the alternative to the translational model (e.g., including two motion model parameters).

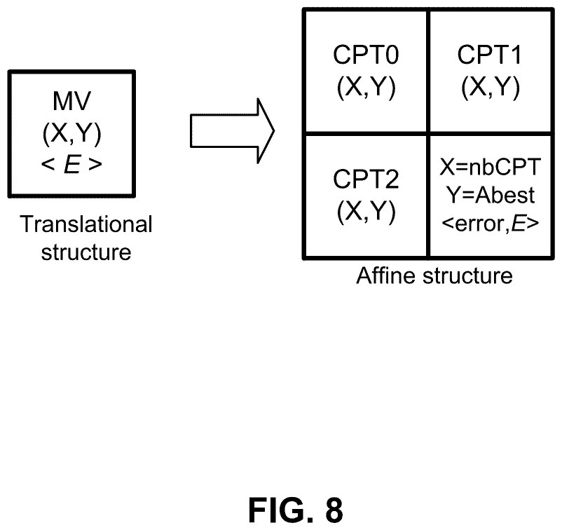

FIG. 8 illustrates an example (e.g., new) affine structure to store control points. For example, FIG. 8 depicts an affine structure embedded into mvAffineCPT to store control points.

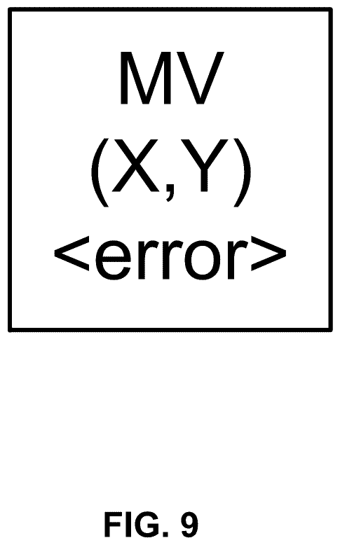

FIG. 9 illustrates an example (e.g., new) affine structure to store a sub-block motion vector and/or a prediction error. In examples, FIG. 9 depicts an affine structure embedded into mvsAffine to store a (e.g., each) sub-block motion vector and/or a prediction error.

To store the affine motion information, at least two (e.g., new) data structures may be described herein. In a first example data structure, mvAffineCPT, may store the block motion model information (e.g., control points in the case of affine motion). In a second example data structure, mvsAffine, may store motion information associated to a (e.g., each) sub-block including the block. Information may include motion vectors and/or a prediction error associated with a sub-block (e.g., associated to each 4×4 sub-block of an 8×8 block). In examples, a first and/or second data structure may be in a prefilter example.

In examples, a current data structure used for storing the translational motion may be extended as illustrated in FIG. 8. For example, mvAffineCPT may store (e.g., may be configured to store) the affine control points and/or block-level affine information. In FIG. 8, CPT0, CPT1 and/or CPT2 may be the three control points of an affine motion (e.g., of an affine motion compensation model). An error may be determined for a block (e.g., the whole block) if/when applying the affine motion with control point(s). An error may be determined based on applying an affine motion model to a block of a first picture and a block of a reference picture. The error may be (e.g., any) metric generated based on applying the motion model. For example, an error may be the sum of absolute differences (SAD) or the sum of squared errors (SSE) (e.g., between the block of a first picture and the block of a reference picture). Examples described herein may use (e.g., in addition to and/or in alternative to an error) a measure of likeliness between a block of a first picture and a block of a reference picture. The unnormalized total error <error> for the block (e.g., for the whole block) may be stored with a normalized version E (e.g., for the block) in the bottom-right element, denoted as <error, E>. X may store one or more (e.g., motion model) parameters (e.g., the number of control points (e.g., two or three), the parameters (four-parameter or six-parameter), and/or the like). Y may store the index (e.g., or a flag) indicating if an affine motion compensation model includes a lower error than a translational compensation motion. In examples, the flag may indicate that a first prediction error associated with a first motion compensated block is less than a second prediction error associated with a second motion compensated block. In examples, the flag may indicate an integer value associated with the motion compensation model with the lowest error (e.g., when two or more motion compensation models are compared).

FIG. 9 illustrates an example of how a data structure for storing the translational motion may be reused. For example, mvsAffine may be provided (e.g., defined) to store the affine motion vectors. In examples mvAffineCPT may store motion information of a sub-block of a block. The motion vectors may be computed (e.g., are normally computed) using either equation (1) or equation (2) (e.g., depending on the parameters (e.g., the number of control points and/or the four-parameters and/or six-parameters) stored in X within mvAffineCPT). A (e.g., each) motion vector may include a horizontal component, denoted X, and/or a vertical component, denoted Y. mvsAffine may be provided (e.g., defined) to store the prediction error (e.g., denoted as <error>) associated to a sub-block (e.g., associated to each of the sub-blocks). For example, the sub-blocks may be of a 2×2 or 4×4 size if/when using 8×8 blocks. For a (e.g., each) block, there may be an array of 4×4 mvsAffine elements (e.g., in an example of 2×2 sub-blocks) or an array of 2×2 mvsAffine elements (e.g., in an example of 4×4 sub-blocks).

Affine information may be stored. One or more examples may be provided to describe how a data structure may be organized. If/when providing motion models (e.g., deploying more advanced motion models), the current data structure may accommodate one or more changes (e.g., the current data structure may be more generic to accommodate the changes).

One or more examples described herein may be performed in a pre-processing operation (e.g., prior to encoding a group of pictures).

An affine motion model based MCTF may be described herein.

An MCTF (e.g., the current MCTF) may include the use of an affine motion model in competition with a translational motion model. In examples, (e.g., as part of a pre-processing operation) an affine motion model may be applied to a block in a first picture (e.g., and a block of a reference picture), and a translational motion model may be applied to the block in the first picture (e.g., and a block of a reference picture), to determine whether the affine motion model or the translational motion model has the lowest prediction error. A translational motion estimation may be (e.g., first) performed at a block level. The affine motion estimation may be performed at a block level (e.g., to determine if a lower error may be achieved compared to the translational motion estimation). As one or more translational motion vectors are tested (e.g., normally tested) to evaluate the prediction error and/or to select the motion with the smallest error, one or more affine motion models (e.g., with one or more control points) may be tested to evaluate the prediction error and/or select the model with the smallest error.

The model (e.g., the affine model or the translational model) that provides the lowest error (e.g., the translational model's error or the affine model's error) may be stored along with its motion information, such as motion vectors, motion model parameters, error, and/or the like (e.g., referred to herein as a competition example). The affine motion control points used in the competition example (e.g., which may be referred to herein as candidates), may include neighboring translational motion vectors, neighboring affine motion vectors, combinations of one or more of the neighboring translational motion vectors and/or one or more of the neighboring affine motion vectors, or functions of one or more of the neighboring translational motion vectors and/or one or more of the neighboring affine motion vectors. In examples, a block (e.g., each block) may use a translational motion vector model with a (e.g., single) motion vector and/or an affine model with a set of 2 or 3 control points. If a block uses an affine model, the block may be divided into sub-blocks, (e.g., for which a motion vector may be derived using either equation (1) or equation (2)).

In examples, if the block size of a first motion model (e.g. an affine motion compensation model) is different from the block size of a second motion model (e.g. a translational motion model), the errors for a spatial area (e.g., the same spatial area) may be compared. For example, if affine motion compensation is performed (e.g., defined) on a 16×16 block and translational motion compensation is performed on a 8×8 block, then the affine motion compensation error for the 16×16 block may be compared to the sum of the errors of the four 8×8 translational motion compensation blocks (e.g., the four 8×8 blocks of the 16×16 block).

In examples, a first and/or second motion compensation (e.g., estimation) may be performed for a block in the first picture using a first and/or second motion compensation model (e.g., a translational model and/or an affine motion model) based on a pre-processing temporal filter reference picture. A first motion compensated block may be obtained from the first motion compensation (e.g., estimation). A second motion compensated block may be obtained from the second motion compensation (e.g., estimation). A first prediction error may be derived from the first prediction block. A second prediction error may be derived from the second prediction block.

A MCTF may be derived based on the comparison of a first prediction error and a second prediction error (e.g., based on the translational motion model and/or the affine motion model). In examples, the MCTF is derived based on the first motion compensation model if the first error prediction is less than the second error prediction. In examples, the MCTF is derived based on the second motion compensation model if the second prediction error is less than the first prediction error.

A filtered first picture may be obtained based on applying the derived MCTF on a block in the first picture (e.g., prior to encoding a group of pictures). A second picture may be encoded by using the filtered first picture as a reference picture (e.g., as part of a pre-processing operation). In examples, the filtered first picture may be encoded first, and/or the second picture may be encoded after the first picture.

In examples, the affine motion estimation may be performed or refined using a gradient descent operation.

In examples, the neighboring translational motion vectors may be used as a first (e.g., an initial) motion vector for an affine motion estimation. In examples, the neighbouring translational motion vector(s) as well as affine motion vector(s) may be used as an initialization for the current block's affine motion estimation.

An enhanced affine motion model may be described herein.

A device may determine whether to perform the affine motion estimation based on a block size, (e.g., to balance the motion model accuracy and the computation burden). In examples, affine motion estimation may be performed if a block size is determined to be larger than a threshold (e.g., affine motion estimation may be performed at a larger block size). In examples, the translational error of a (e.g., each) sub-block may be added together, and/or the added error may be compared with the affine prediction error (e.g., if an affine motion estimation is determined to be performed based on a block size as described herein). For example, in a region of 16×16, a translational motion estimation on four 8×8 sub-blocks may be computed and/or the translational motion prediction error on (e.g., each) sub-block(s) may be added together. An affine motion estimation may be performed on the 16×16 block, and/or the affine motion estimation prediction error may be compared to the added translational motion prediction error. The optimal (e.g., best) model may be stored (e.g., the model with the lowest prediction error).

In examples described herein, the block under consideration (e.g., a current block) may include one or more (e.g., several) translational motion vectors, which may be compared to an affine model (e.g., which may be in competition with one affine model) including a set of two or three control points. One or more candidate control points may be included in the competition (e.g., may be included in the comparison of the translational motion model and the affine motion model).

An example use of one or more (e.g., advanced) motion model(s) may be described herein. In examples, a (e.g., advanced) motion model may be used to determine a MCTF of a block of a reference picture. In examples, an MCTF may be derived based on an advanced motion model.

Examples described herein may include (e.g., extend to) an affine motion model. One or more (e.g., other) motion models, such as affine, perspective and/or the like, may be in competition with the translational model (e.g., one or more motion models may perform MCTF of the reference). In examples, a prediction error associated with a translational motion compensation model may be compared to a prediction error associated with a (e.g., advanced) motion model. A (e.g., advanced) motion model may include at least one of an affine motion model, a perspective motion model, a homographic motion model, a piecewise motion model, or an artificial intelligence (AI)-based motion model estimation (e.g., a neural network, deep neural network, and/or the like). The selected motion model may be based on the generated error as described herein.

In examples, an 8×8 translational motion estimation may be performed (e.g., first) and/or an affine motion estimation may be performed (e.g., second) at the 8×8 block to determine if a lower prediction error is be achieved. A perspective motion estimation may be performed (e.g., third) at the 8×8 block to determine if a lower prediction error may be achieved (e.g., lower than one or more motion estimation model(s)). The model that brings the lowest cost (e.g., the model that includes the lowest prediction error) may be stored along with the model motion information (e.g., motion model parameters) associated with the model (e.g., the motion model type, motion vectors and/or the prediction error from the determined model).

In examples, a (e.g., each) block under consideration may include one or more (e.g., several) translational motion vectors, which may be in competition with one or more (e.g., an alternative) motion models and/or candidates covering the block area.

In examples, an AI based motion model may be used to derive the MCTF that is applied to the current and/or reference picture (e.g., for filtering the reference picture). In examples, if an AI motion model is used, no other motion model may be applied in competition.

A (e.g., separate) filter design for one or more motion models may be described herein.

In an MCTF, a bi-lateral filter may be used to filter the reference frame. In examples, a first filter design may be used for a first motion mode, and/or a second filter design may be used for a second motion model (e.g., different filter designs may be used for different motion models). For example, a bi-lateral filter may be used (e.g., only) for the translational model and/or a gaussian filter may be used for an affine motion model.

In examples, a first filter parameter may be used for a first motion model and/or a second filter parameter may be used for a second motion model (e.g., different filter parameters (e.g. hyper parameters) may be used for different motion models). A filter may be configured with one or more filter parameter(s), based on a motion model type (e.g., filter parameters may be learned offline for each motion model type). In examples, a filter may be configured with one or more filter parameter(s), based on a motion compensated block and/or a metric computed based on the motion compensated block (e.g., motion compensated prediction error).

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various methods and aspects described herein can be used to modify one or more modules. For example, the intra predictors and inter predictors described with respect to FIGS. 2 and 3 may be implemented as one or more modules and modified according to the various embodiments of the present disclosure.

The various embodiments described herein provide at least the following features, devices or aspects, alone or on any combination, across various claim categories and types:

Encoding, into coded video data, syntax elements that can enable the decoder to decode the coded video data, according to any of the embodiments described herein.

Video data (e.g., a bitstream) that may include one or more of the described syntax elements, or variations thereof, whether transmitted, stored, or otherwise made available.

Creating, transmitting, receiving, and/or decoding of the bitstream.

An electronic device (e.g., TV, set-top box, mobile phone, tablet, etc.) that tunes a channel to receive a bitstream or that receives such bitstream over the air. The electronic device decodes the syntax elements from the bitstream, and, optionally, displays (e.g., via a monitor or other type of display) a resulting image.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

“Decoding,” as used herein, encompasses all or part of the processes performed, for example, on an encoded sequence to produce an output suitable for display. In some embodiments, such processes include one or more of the processes typically performed by a decoder, for example, entropy decoding, inverse quantization, etc. Whether the phrase “decoding process” is intended to refer to a subset of operations or generally to the broader decoding process will be clear based on the context of the specific description and will be well understood by those skilled in the art.

“Encoding,” as used herein, encompasses all or part of the processes performed, for example, on input video data an order to produce an encoded bitstream. Additionally, the terms “reconstructed” and “decoded” may be used interchangeably, the terms “encoded” or “coded” may be used interchangeably, the terms “image,” “picture,” “sub-picture,” “slice,” and “frame” may be used interchangeably, and the terms “pixel” and “sample” may be used interchangeably.

The present disclosure refers to information, for example, syntax elements, that can be transmitted or stored. Such information can be packaged or arranged in a variety of manners, including for example manners common in video standards such as putting the information into a sequence parameter set (SPS), a picture parameter set (PPS), a network abstraction layer (NAL) unit, a header (for example, a NAL unit header, or a slice header), or an SEI message. Other manners are also available, including, for example, manners that are common for system level or application-level standards such as signaling the information into one or more of the following:
session description protocol (SDP), for example as described in RFCs and/or used in conjunction with real-time transport protocol (RTP) transmission.
hypertext transfer protocol (HTTP) live Streaming (HLS) manifest transmitted over HTTP.
dynamic adaptive streaming over HTTP (DASH) media presentation description (MPD) descriptors, for example as used in DASH and transmitted over HTTP.

RTP header extensions, for example as used during RTP streaming.

International Organization for Standardization (ISO) base media file format, for example, as used in Omnidirectional MediA Format (OMAF).

As used herein, “signal” and “signaling” refer to, among other things, indicating information to a decoder. For example, in some embodiments the encoder signals a quantization matrix for de-quantization, whereby the same parameter may be used for both encoding and decoding. In some embodiments, the signaling may be explicit, such that information (e.g., a particular parameter) is transmitted to the decoder enabling the decoder to use the same particular parameter. In some embodiments, the signaling may be implicit, in that the information (e.g., a particular parameter) is indicated based on other information at or transmitted to the decoder or derived or selected by the decoder based on information available at the decoder. By not transmitting the information (e.g., the particular parameter), bit savings is thus realized in some embodiments. In some embodiments, one or more syntax elements or flags are used to signal information to a decoder. While the preceding relates to the verb form of the word “signal”, the word “signal” can also be used herein as a noun.

In some embodiments, signals may be produced that are formatted to carry information that may be stored or transmitted. Such information may include, for example, instructions for performing a method, or data produced by one of the described implementations (e.g., a bitstream of a described embodiment). Such a signal may be formatted, for example, as an electromagnetic wave or as a baseband signal. The formatting may include, for example, encoding a data stream and modulating a carrier with the encoded data stream. The information that the signal carries may be, for example, analog or digital information. The signal may be transmitted over a variety of different wired or wireless links and may be stored on a processor-readable medium.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

What is claimed is:

1. A device for video encoding, comprising:
a processor configured to:
obtain at least one temporal filter reference picture associated with a picture;
perform, for a block in the picture, a motion estimation associated with an advanced motion model type based on the at least one temporal filter reference picture to obtain a motion compensated block;
derive a motion compensated temporal filter (MCTF) at least based on the motion estimation; and
obtain a filtered picture based at least on applying the derived MCTF on the block in the picture.

2. The device of claim 1, wherein the processor is further configured to:
determine a first prediction error associated with the motion compensated block;
perform, for the block in the picture, a second motion estimation associated with a second motion model type based on the at least one temporal filter reference picture to obtain a second motion compensated block;
determine a second prediction error associated with the second motion compensated block; and
derive the MCTF further based on a comparison of the first prediction error and the second prediction error.

3. The device of claim 2, wherein the MCTF is derived based on the advanced motion model type if the first prediction error is less than the second prediction error.

4. The device of claim 2, wherein the MCTF is derived based on the second motion model type if the second prediction error is less than the first prediction error.

5. The device of claim 2, wherein the processor is further configured to store a motion model type, a motion vector, a motion model parameter, or an prediction error value associated with the MCTF.

6. The device of claim 2, wherein the motion estimation is based on a temporally neighboring reference picture and the second motion estimation is performed based on a hierarchical motion estimation.

7. The device of claim 1, wherein the advanced motion model type comprises at least three motion model parameters.

8. The device of claim 1, wherein the advanced motion model type is at least one of an affine motion model, a perspective motion model, a homographic motion model, a piecewise motion model, or an artificial intelligence (AI)-based motion model.

9. The device of claim 1, wherein the processor is further configured to encode a second picture by using the filtered picture as a reference picture.

10. The device of claim 9, wherein the second picture is encoded after encoding the filtered picture.

11. The device of claim 1, wherein the at least one temporal filter reference picture comprises at least one of a preceding neighboring picture in a display order of a group of pictures, or a succeeding neighboring picture in the display order of the group of pictures.

12. The device of claim 1, wherein the derived MCTF is applied on the block in the picture during pre-processing.

13. A method for video encoding, comprising:
obtaining at least one temporal filter reference picture associated with a picture;
performing, for a block in the picture, a motion estimation associated with an advanced motion model type based on the at least one temporal filter reference picture to obtain a motion compensated block;
deriving a motion compensated temporal filter (MCTF) at least based on the motion estimation; and
obtaining a filtered picture based at least on applying the derived MCTF on the block in the picture.

14. The method of claim 13, wherein the method further comprise:
determining a first prediction error associated with the motion compensated block;
performing, for the block in the picture, a second motion estimation associated with a second motion model type based on the at least one temporal filter reference picture to obtain a second motion compensated block;
determining a second prediction error associated with the second motion compensated block; and
deriving the MCTF further based on a comparison of the first prediction error and the second prediction error.

15. The method of claim 14, wherein the MCTF is derived based on the advanced motion model type if the first prediction error is less than the second prediction error and wherein the MCTF is derived based on the second motion model type if the second prediction error is less than the first prediction error.

16. The method of claim 14, wherein the method further comprises storing a motion model type, a motion vector, a motion model parameter, or an prediction error value associated with the MCTF.

17. The method of claim 14, wherein the motion estimation is based on a temporally neighboring reference picture and the second motion estimation is performed based on a hierarchical motion estimation.

18. The method of claim 13, wherein the advanced motion model type is at least one of an affine motion model, a perspective motion model, a homographic motion model, a piecewise motion model, or an artificial intelligence (AI)-based motion model.

19. The method of claim 13, wherein the method further comprises encoding a second picture by using the filtered picture as a reference picture.

20. The method of claim 13, wherein the derived MCTF is applied on the block in the picture during pre-processing.
